(19) United States
(12) Patent Application Publication
(10) Pub. No.: US 2004/0163286 A1
(43) Pub. Date: Aug. 26, 2004

(54) Daily calendar holder

(76) Inventor: Bobbie J. Evans, Woodbridge, VA (US)

Correspondence Address: Richard C. Litman, LITMAN LAW OFFICES, LTD., P.O. Box 15035, Arlington, VA, 22215, US

(21) Appl. No.: 10/780,708

(22) Filed: Feb. 19, 2004

Related U.S. Application Data
(60) Provisional application No. 60/449,585, filed on Feb. 26, 2003.

(51) Int. Cl. G09D 3/02

(52) U.S. Cl. 40/122

(57) ABSTRACT

A daily calendar holder includes an elongated base, preferably in the form of a wooden block. The base includes a groove formed in the top surface of the block extending along the length of the block from a first end to a second end of the block. The daily calendar holder further includes an elongated transparent plate having a top edge, a bottom edge and two side edges. Three parallel slots each sized for removably receiving a daily calendar sheet are formed in the plate with openings along the top edge of the plate. The bottom edge of the plate is permanently secured within the groove in the base. A tag for displaying emblems, company logos and/or information identifying the owner of the holder is permanently secured along one side edge of the base.

### CROSS-REFERENCE TO RELATED APPLICATION

This application claims the benefit of U.S. Provisional Patent Application Serial No. 60/449,585, filed Feb. 26, 2003.

### BACKGROUND OF THE INVENTION

1. Field of the Invention

The present invention relates to display holders, and more specifically to holders for displaying a plurality of daily calendars.

2. Description of Related Art

Holders for changeable calendar displays are known and may take on many different forms depending on the type of calendar display that is desired. For example, U.S. Pat. No. 3,670,436 issued Jun. 20, 1972 to Weissman teaches a calendar consisting of a plurality of cubes having date, month and day indicia marked on the sides of the cubes. The cubes are movably held in a substantially L-shaped holder having a base member inclined from front to rear. A rear member is attached to the base member to prevent the cubes from slipping backward in the holder due to the inclined base member. A lip extends upwardly from the front portion of the base member at each end of the holder to mask portions of the indicia on the cubes.

Padgett (British Patent Number 378,969) teaches holders for yearly calendars that are triangular, square or equivalent shape in cross section. Each month of the year can be exhibited from the flat sides in series of four or three months, whereby the date of the week or a certain date of the month is readily ascertainable. Metal frames, each containing a glazed cover, are hinged to each other and folded into a shape for displaying the calendar. A sheet of material with the monthly calendar indicia displayed on one side in three rows of four months is folded and placed within the holder so that a different row of months is visible in each separate frame.

None of the above inventions and patents, taken either singly or in combination, is seen to describe the instant invention as claimed.

### SUMMARY OF THE INVENTION

The present invention provides a daily calendar holder for holding 5.5×8.5-inch daily calendar sheets such as those that may be printed from the “MICROSOFT” Outlet Express program. The date, personal identification, daily itinerary, and a monthly calendar are the types of information that may be printed from the program to form the daily calendar sheet. The daily calendar sheets of at least three different personnel members are displayed in the daily calendar holder. The holder can be conveniently placed upon the top of a table or desk for easy viewing.

The daily calendar holder comprises an elongated base, preferably in the form of a wooden block. The base includes a groove formed in the top surface of the block extending along the length of the block from a first end to a second end of the block.

The daily calendar holder further comprises an elongated transparent plate having a top edge, a bottom edge and two side edges. Three parallel slots, each sized for removably receiving a 5.5×8.5-inch daily calendar sheet, are formed within the plate with the openings of the slots arranged along the top edge of the plate. The bottom edge of the plate is permanently secured within the groove in the base.

A tag is permanently secured along one side edge of the base for displaying emblems, company logos and/or information identifying the owner of the holder.

Accordingly, it is a principal object of the invention to provide a daily calendar holder wherein the daily calendar events of three days for a single person can be displayed.

It is another object of the invention to provide a daily calendar holder wherein the daily calendar events of three different people can be displayed.

It is a further object of the invention to provide a daily calendar holder that grants easy access to the daily calendar events of selected persons to a person responsible for tracking the whereabouts of the selected persons.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a daily calendar holder according to the present invention.

FIG. 2 is a front view of a daily calendar holder according to the present invention.

FIG. 3 is a cross sectional view of a daily calendar holder taken along line 3-3 of FIG. 2.

FIG. 4 is a top view of a daily calendar holder according to the present invention.

### DETAILED DESCRIPTION OF THE PREFERRED EMBODIMENT

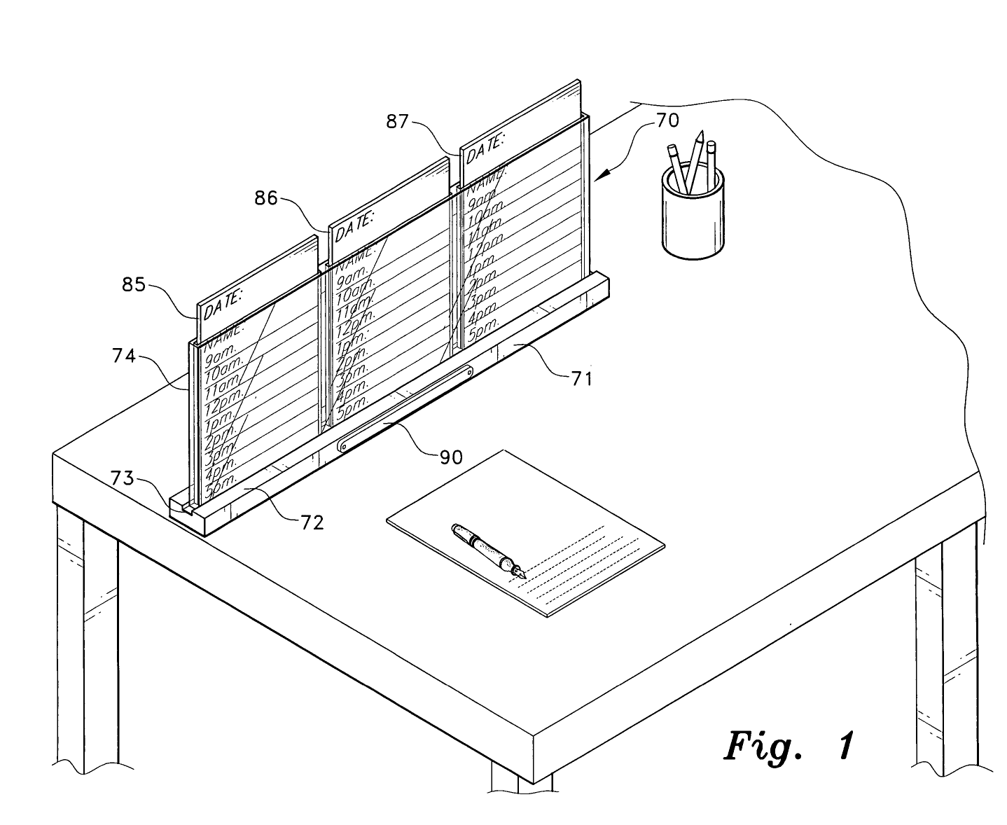

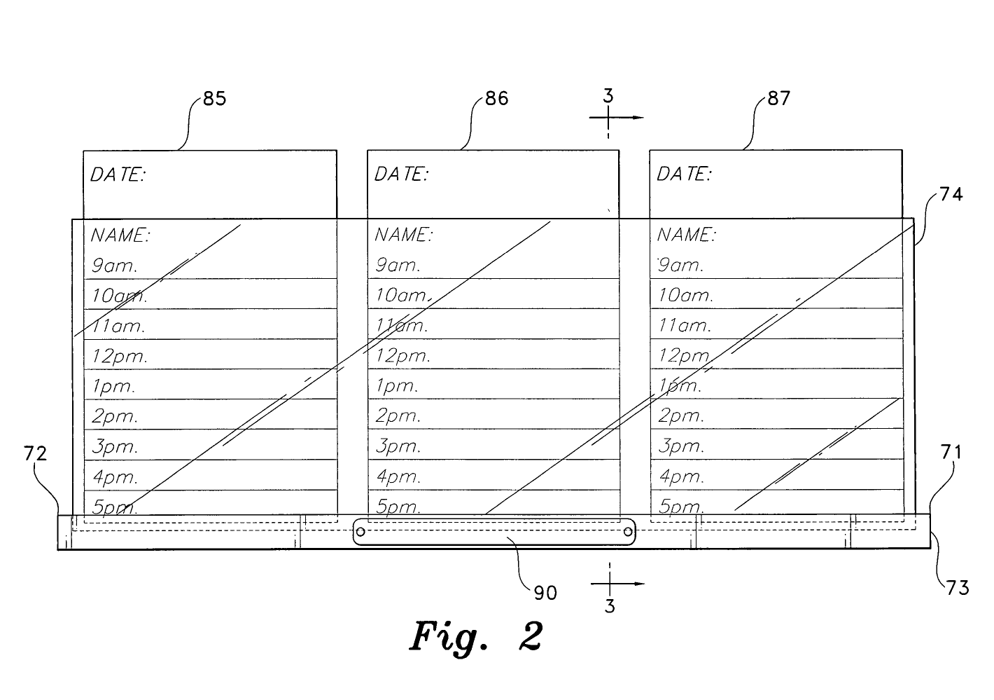

The present invention provides a daily calendar holder for holding 5.5×8.5-inch daily calendar sheets 85-87 (see FIGS. 1 and 2) such as those that may be printed from computer programs like the “MICROSOFT” Outlet Express program. Referring to FIG. 1, the holder 70 includes a base 71, preferably formed from an elongated block of wood. The base 71 may, however, be constructed from any suitable material. The base 71 includes a groove 73 formed in the top surface 72 of the block extending along the length of the block from a first end to a second end of the block.

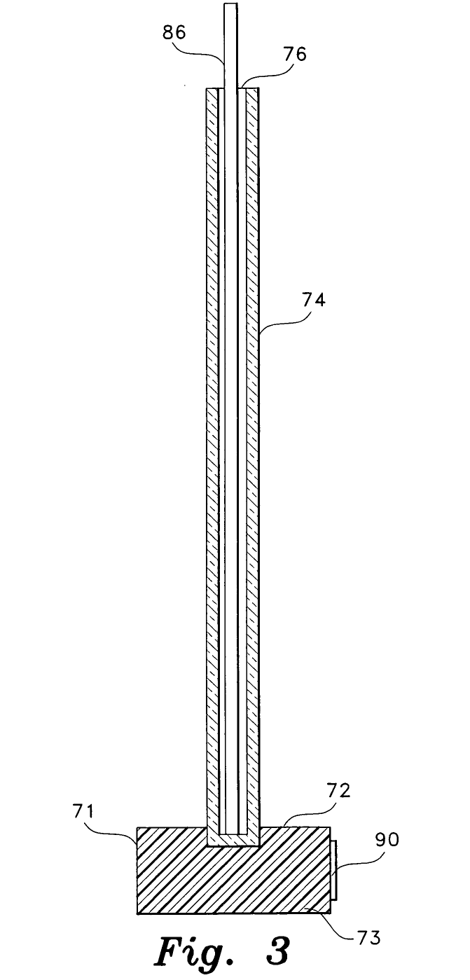

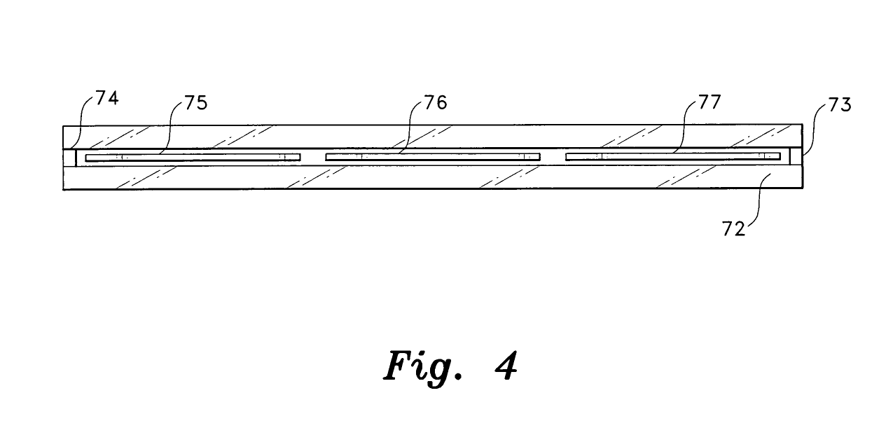

The holder 70 further includes an elongated transparent plate 74 having a front face, a back face, a top edge, a bottom edge and two side edges. Plate 74 may be formed of “PLEXIGLAS” or any suitable transparent plastic material. As best seen in FIGS. 3 and 4, parallel slots, each sized for removably receiving one 5.5×8.5-inch daily calendar sheet, are formed within plate 74 with openings 75-77 positioned along the top edge of plate 74 as may be seen in FIG. 4. The bottom edge of the plate 74 is permanently secured within the groove in the top surface 72 of the base 71 by adhesives or other suitable means (not shown). Preferably, the base 71 and transparent plate 74 are each at least 17-inches in length. The slots in the transparent plate 74 are 5.5-inches in width and 8-inches in length.

A tag or plaque 90 is further provided in the holder 70 for displaying information such as emblems, company logos and/or the identification the owner of the holder. An adhesive or other suitable fastening means (not shown) permanently secures the plaque 90 to the front of the base 71.

It is to be understood that the present invention is not limited to the sole embodiment described above, but encompasses any and all embodiments within the scope of the following claims.

I claim:

1. A daily calendar holder comprising:
a base, said base being in the form of an elongated block having a top surface, a bottom surface, a first side surface, a second side surface, a first end and a second end;
a groove formed in said top surface of said block extending along the length of said block from the first end to the second end of said block;
an elongated transparent plate having a front face, a back face, a top edge, a bottom edge and two side edges;
said plate having three parallel calendar slots formed therein with each slot having an opening along the top edge of said plate, each slot being sized for removably receiving a daily calendar sheet;
said groove in said base being sized to snugly receive the bottom edge of the plate therein and support said plate in an upright position on said base; and
an adhesive permanently securing said plate within the groove in said base.

2. The daily calendar holder according to claim 1, further comprising:
a tag for displaying emblems, company logos and/or information identifying the owner of said holder is permanently secured along one side edge of the base.

3. The daily calendar holder according to claim 2, wherein
said block is formed of wood and said transparent plate is formed of “PLEXIGLAS”.

4. The daily calendar holder according to claim 3, wherein
each slot is 5.5-inches in width and at least 8-inches in length.

5. The daily calendar holder according to claim 1, wherein said transparent plate is formed from any suitable transparent plastic material and said base is formed of wood.

6. The daily calendar holder according to claim 5, further including:
a tag for displaying emblems, company logos and/or information identifying the owner of said the holder permanently secured along one side edge of the base.

7. The daily calendar holder according to claim 6, wherein each slot is 5.5-inches in width and 8-inches in length.
